(19) United States
(12) Patent Application Publication
(10) Pub. No.: US 2009/0222288 A1
(43) Pub. Date: Sep. 3, 2009

(54) SYSTEM AND METHOD FOR PROVIDING TELEPHONE ACCESS BY PATIENTS TO MEDICAL PERSONNEL

(76) Inventor: David A. Slater, Irving, TX (US)

Correspondence Address: HITT GAINES P.C., P.O. BOX 832570, RICHARDSON, TX, 75083, US

(21) Appl. No.: 12/395,600

(22) Filed: Feb. 27, 2009

Related U.S. Application Data
(60) Provisional application No. 61/032,700, filed on Feb. 29, 2008.

(51) Int. Cl. G06Q 50/00; G06Q 30/00; H04M 3/42

(52) U.S. Cl. 705/3; 705/34; 379/207.13

(57) ABSTRACT

A physician/patient communication system and a method of managing physician/patient communication. In one embodiment, the system includes: (1) an account manager configured to interact with at least one patient and at least one physician to allow at least one patient account and at least one physician account to be established, (2) a report generator coupled to the account manager and configured to provide one or more reports to the at least one patient and the at least one physician, (3) a matching engine coupled to the report generator and configured to match the at least one patient with the at least one physician and (4) a telephony interface coupled to the matching engine and configured to enable communication between the at least one patient and the at least one physician.

### CROSS-REFERENCE TO RELATED APPLICATION

This application claims the benefit of U.S. Provisional Application Ser. No. 61/032,700, filed by Slater on Feb. 28, 2008, entitled “System and Method for Providing Telephone Access by Patients to Medical Personnel,” commonly assigned with this application and incorporated herein by reference.

### TECHNICAL FIELD

This application is directed, in general, to a computer-based communication systems and, more specifically, to a system and method for providing telephone access by patients to medical personnel.

### BACKGROUND

The physician-patient relationship has for many centuries been among the most personal and trusted of relationships. Unfortunately, the face of primary care is rapidly changing. Essentially gone are the days when a physician would call to follow up with a patient to see if the patient was still sick or discuss the patient's lab results in detail while waiting for the insurance company to reimburse the physician. The reason underlying this fundamental change is financial in nature. While the patient benefits from the interaction, the physician bears the ever-increasing cost of operating an office.

Most patients agree that their physician seems rushed or spends less time than what they would like, or expect. This is primarily due to the structure of a visit as the patient's insurance company (including Medicare) dictates. They do not pay for the patient's visit based on its length, but rather for a pre-determined amount based on which of five levels are billed. What this means is that if the patient's physician spends too much time in any one visit or even on the phone, the revenue will be insufficient to maintain the overhead of the office. As a result, a patient is likely to have health problems that go unaddressed because both the physician and the patient is compelled to keep up the pace the insurance company establishes.

### SUMMARY

One aspect provides a physician/patient communication system. In one embodiment, the system includes: (1) an account manager configured to interact with at least one patient and at least one physician to allow at least one patient account and at least one physician account to be established, (2) a report generator coupled to the account manager and configured to provide one or more reports to the at least one patient and the at least one physician, (3) a matching engine coupled to the report generator and configured to match the at least one patient with the at least one physician and (4) a telephony interface coupled to the matching engine and configured to enable communication between the at least one patient and the at least one physician.

In another embodiment, the system includes: (1) an account manager configured to interact with at least one patient and at least one physician via one or more of: (1a) a browser, (1b) electronic mail and (1c) a telephone to allow at least one patient account and at least one physician account to be established, (2) a report generator coupled to the account manager and configured to provide one or more reports to the at least one patient and the at least one physician, (3) a matching engine coupled to the report generator and configured to match the at least one patient with the at least one physician and (4) a telephony interface coupled to the matching engine and configured to enable communication between the at least one patient and the at least one physician, the account manager, the report generator and the matching engine embodied at least in part in a sequence of software instructions executable in a general-purpose computer.

Another aspect provides a method of managing physician/patient communication. In one embodiment, the method includes: (1) interacting with at least one patient and at least one physician to allow at least one patient account and at least one physician account to be established, (2) providing one or more reports to the at least one patient and the at least one physician, (3) matching the at least one patient with the at least one physician and (4) enabling communication between the at least one patient and the at least one physician.

### BRIEF DESCRIPTION

Reference is now made to the following descriptions taken in conjunction with the accompanying drawings, in which:

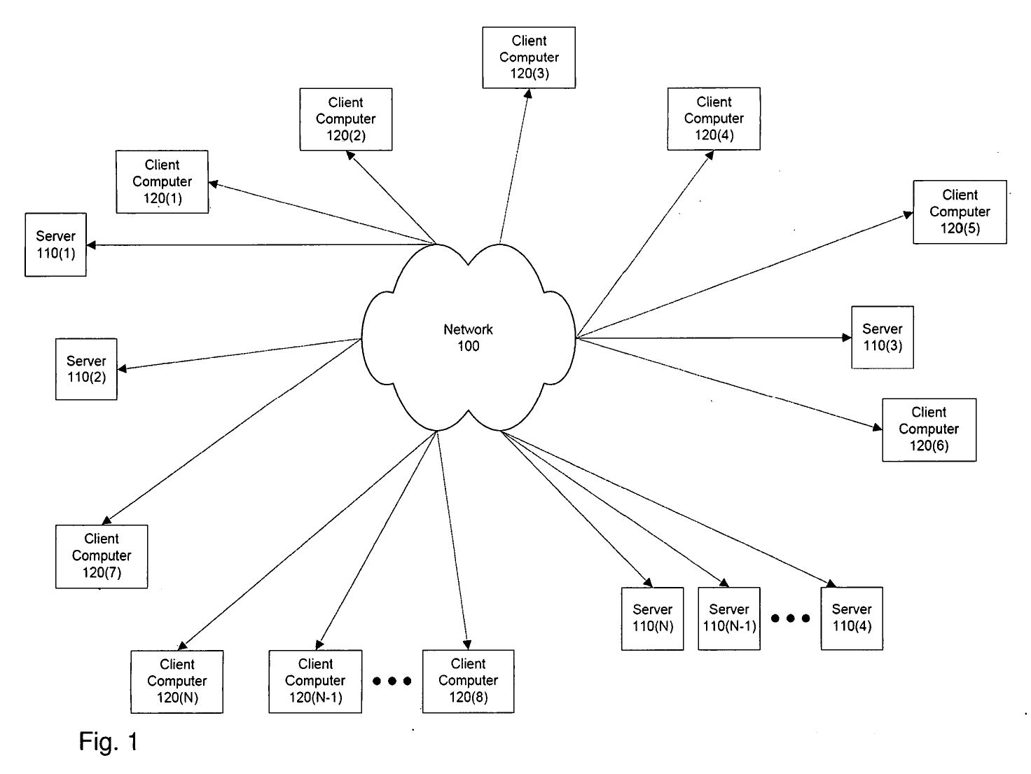

FIG. 1 is a block diagram illustrating a network environment in which embodiments of the invention may be practiced;

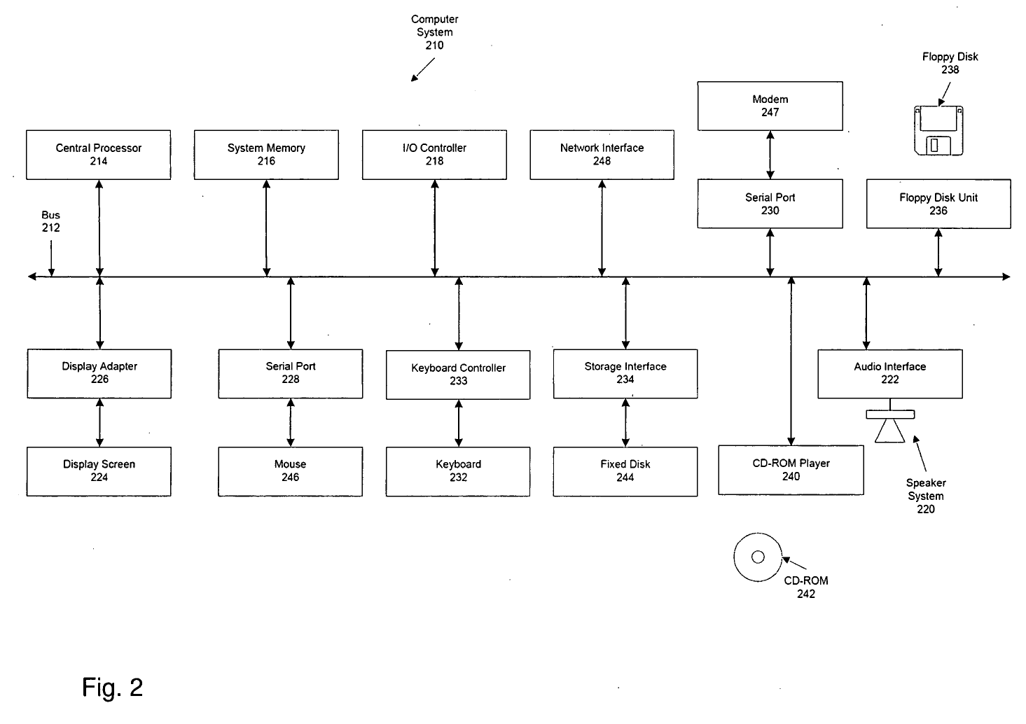

FIG. 2 is a block diagram illustrating a computer system suitable for implementing embodiments of the invention;

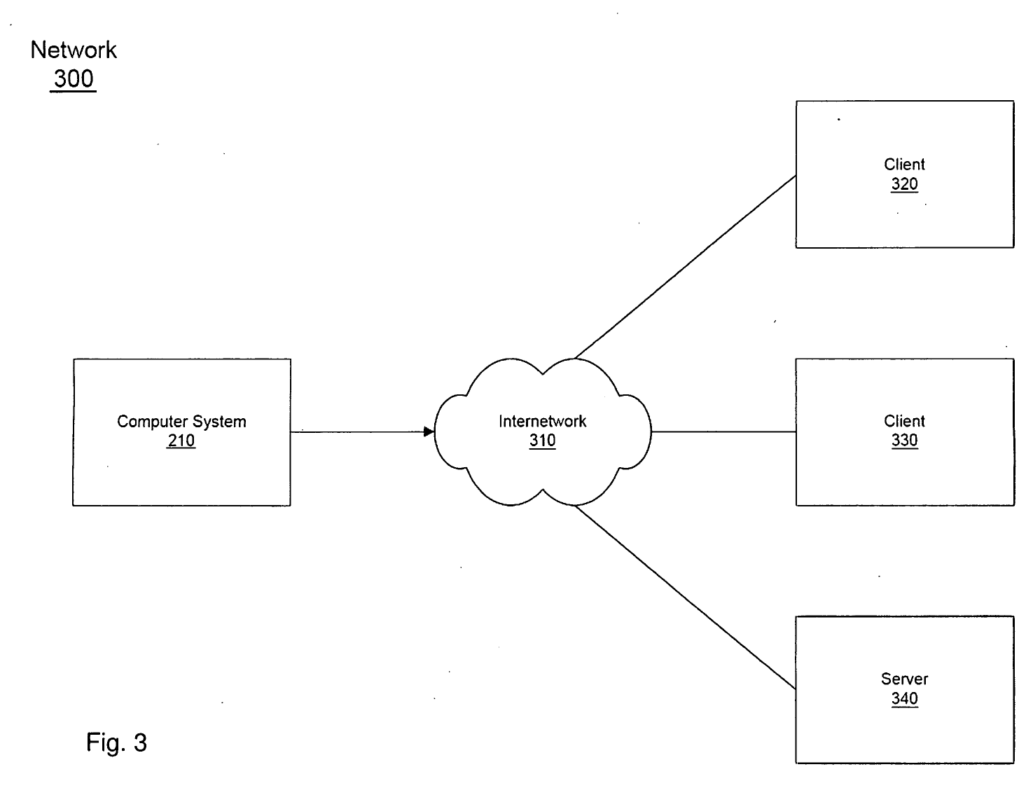

FIG. 3 is a block diagram illustrating the interconnection of the computer system of FIG. 2 to client and host systems;

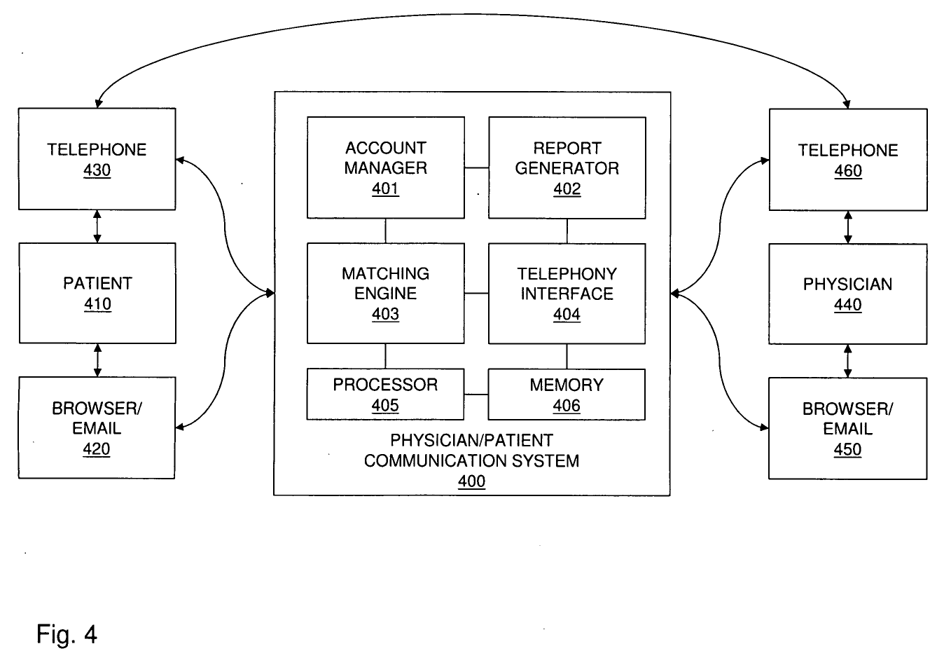

FIG. 4 is a block diagram of one embodiment of a physician/patient communication system constructed according to the principles of the invention;

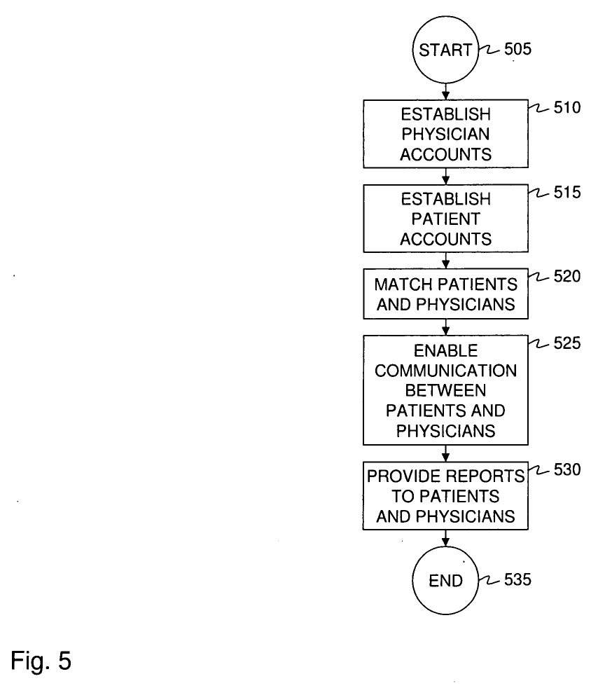

FIG. 5 is a flow diagram of one embodiment of a method of managing physician/patient communication carried out according to the principles of the invention;

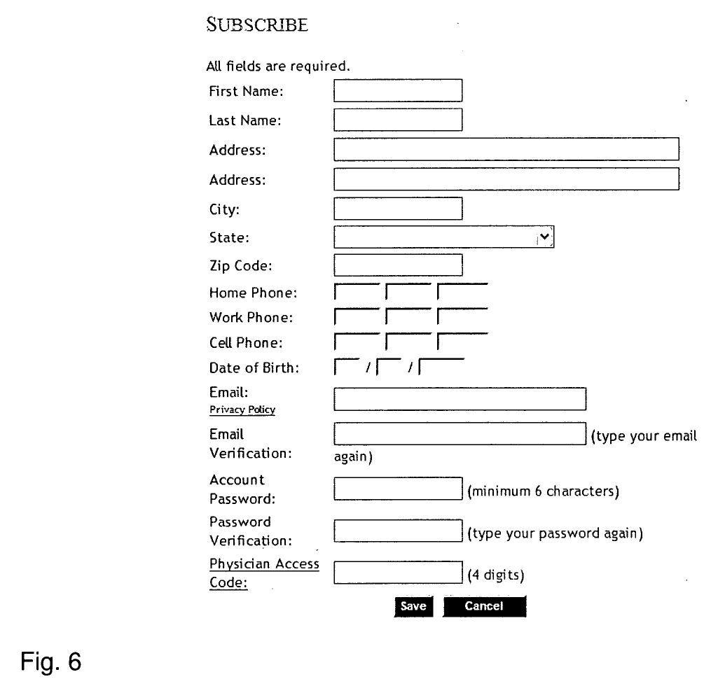

FIG. 6 is a portion of an image presentable on a computer monitor and regarding the establishing of an account for a patient;

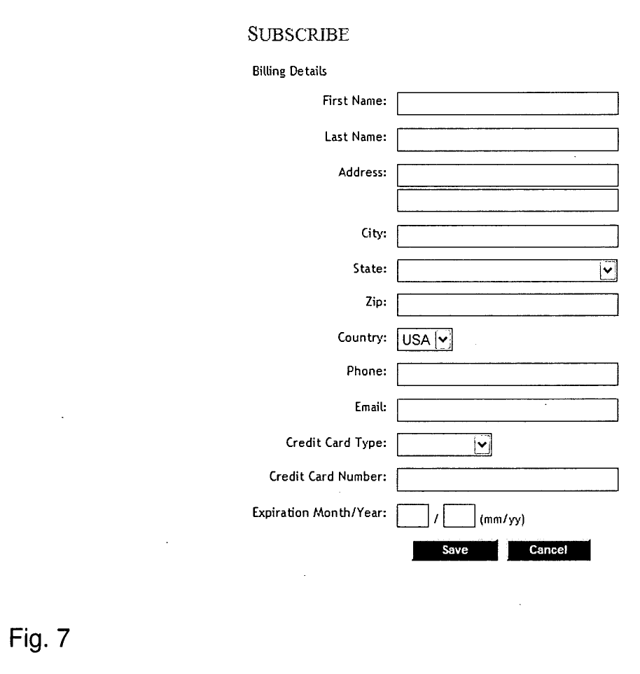

FIG. 7 is a portion of an image presentable on a computer monitor and regarding billing details for a patient;

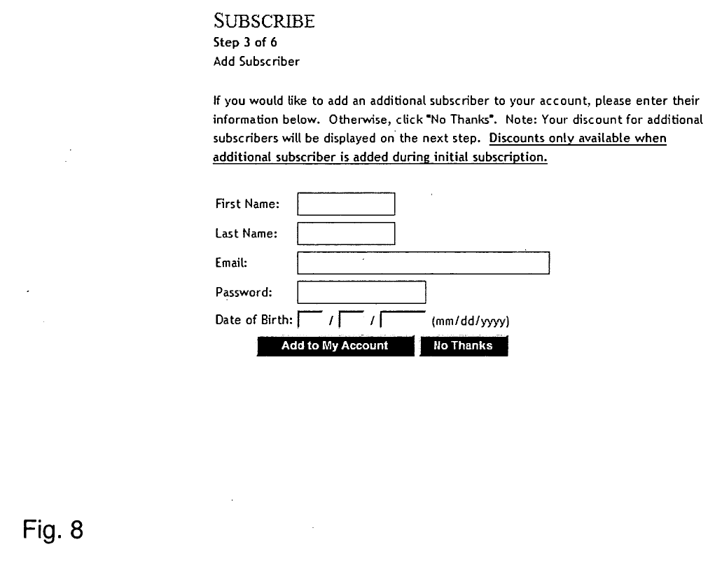

FIG. 8 is a portion of an image presentable on a computer monitor and regarding the addition of a patient to a given account;

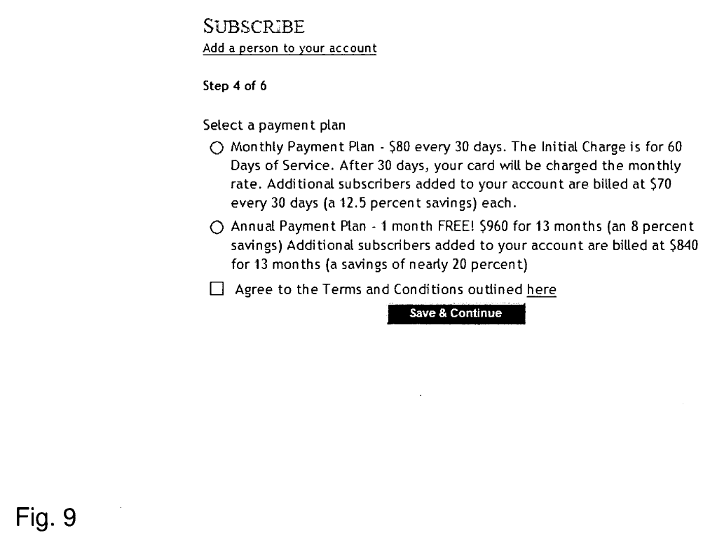

FIG. 9 is a portion of an image presentable on a computer monitor and regarding the choosing of a payment plan for a subscribing patient;

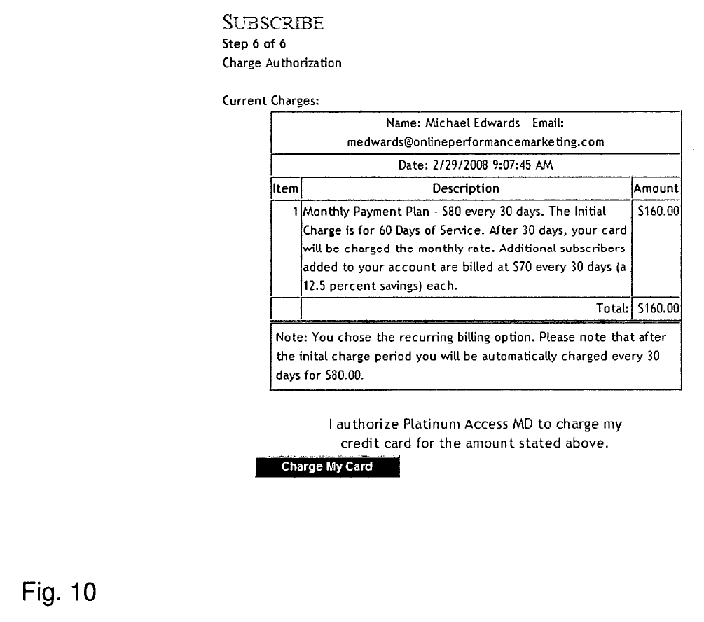

FIG. 10 is a portion of an image presentable on a computer monitor and regarding medical service charge authorization for a subscribing patient;

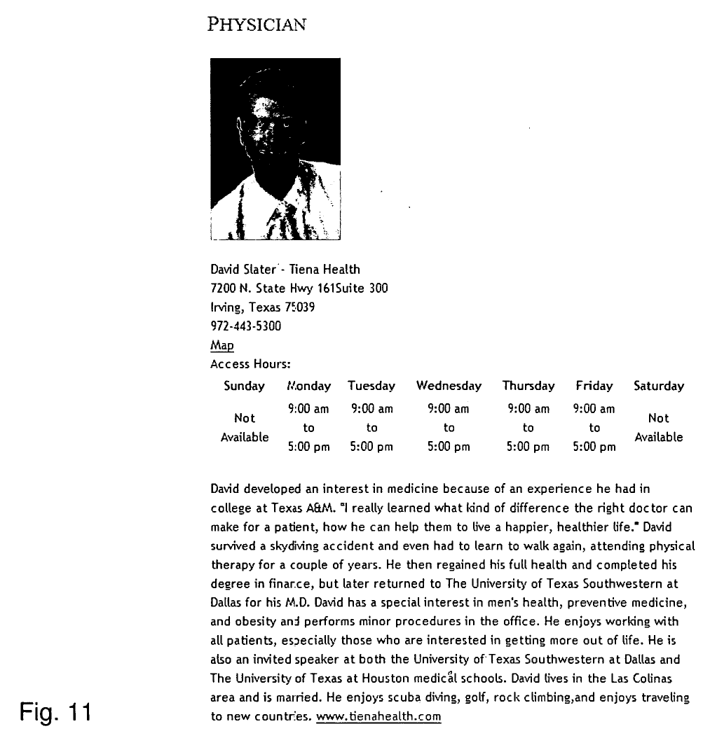

FIG. 11 is a portion of an image presentable on a computer monitor and regarding biographical information details for a subscribing physician;

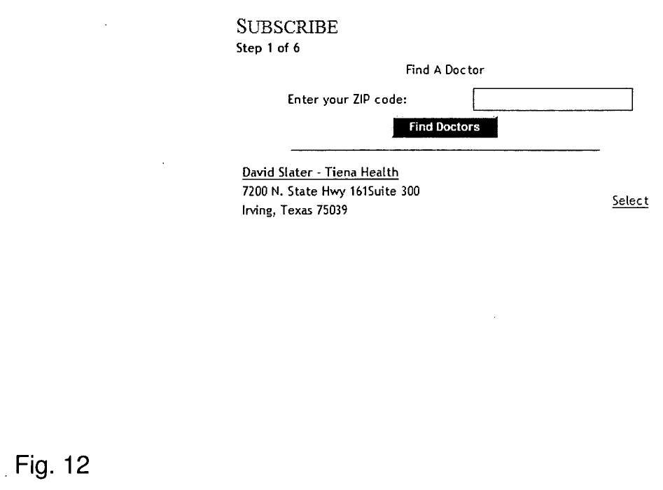

FIG. 12 is a portion of an image presentable on a computer monitor and regarding patient/physician matching;

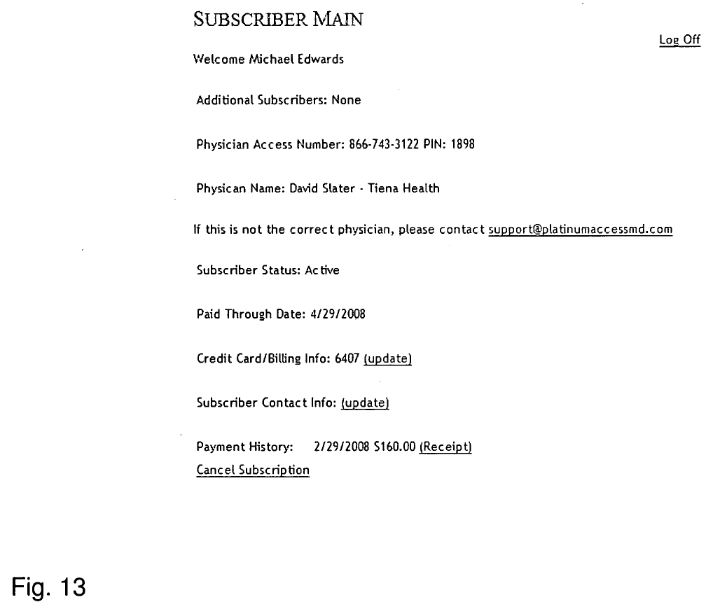

FIG. 13 is a portion of an image presentable on a computer monitor and regarding summary information for a subscribing patient;

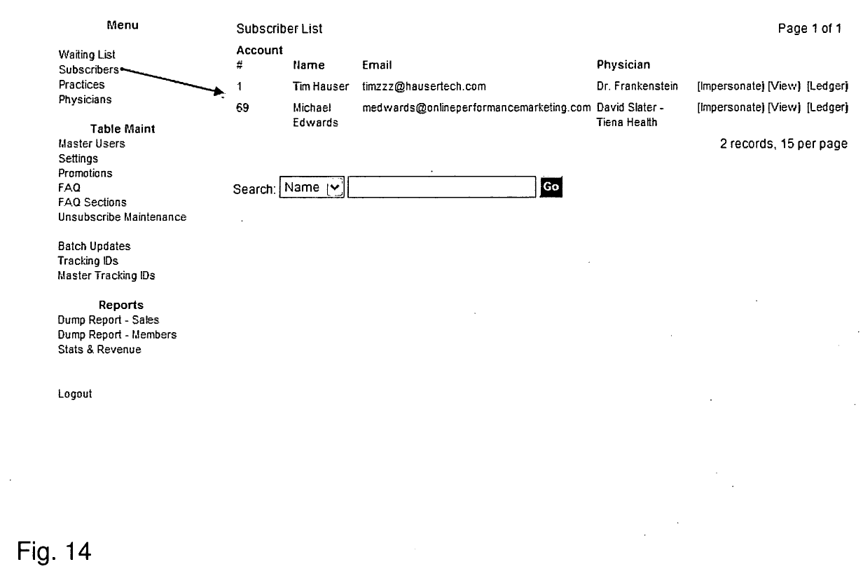

FIG. 14 is a portion of an image presentable on a computer monitor and regarding a list of patients for physicians; and

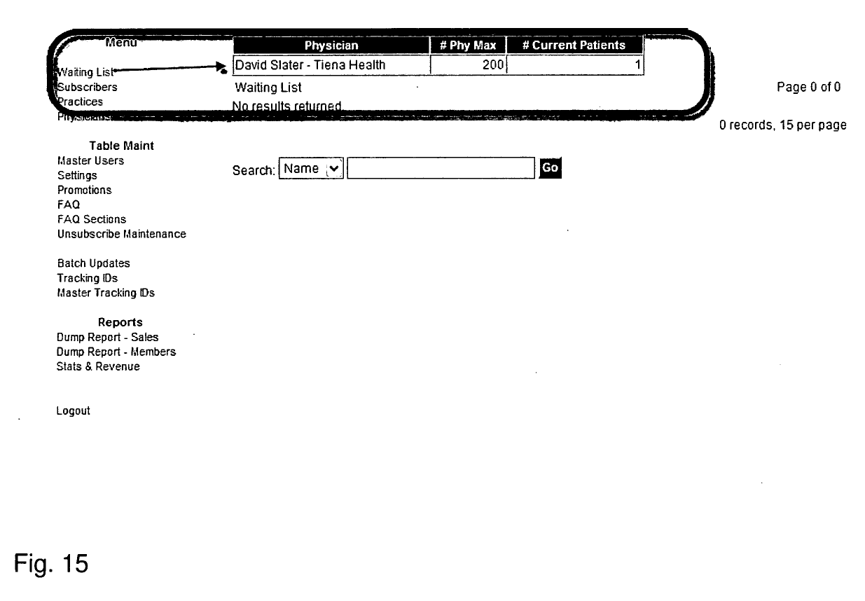

FIG. 15 is a portion of an image presentable on a computer monitor and regarding a waiting list for a subscribing physician.

### DETAILED DESCRIPTION

It should be understood that “physician,” as that term is used herein, includes not only medical doctors (MDs), but also osteopaths, chiropractors, dentists and veterinarians. Also, while “physician” normally refers only to those licensed to practice medicine, “physician” is also intended to encompass healthcare providers in general, including nurse practitioners, nurses, paramedics, psychologists and other counselors.

As stated above, a patient is likely to have health problems that go unaddressed because both physicians and patients are conforming to a pattern of conduct prompted by the reimbursement policies of insurance companies. What is needed is a way to reestablish the closer working relationship that existed beforehand. More specifically, what is needed is a way to reestablish communication between physicians and patients at the time of the patient's choosing.

In accordance with various embodiments of systems and methods described herein, a patient can now have access to a physician with the physician/patient communication system which routes the patient's call based on the patient's subscription status and the physician's hours of operations. Certain embodiments of the systems provide one or more of: ready access to questions regarding the patient's health without an insurance co-pay, straightforward solutions for simple illnesses, timely resolutions of a patient's questions or concerns, affordable service, a respecting of the patient's valuable time and a restoration of medically necessary communication between a physician and patient to improve both the patient's health and sense of well-being.

Physicians can augment their existing practice by providing their services through various embodiments of the disclosed system and method, while maintaining privacy and control over that access. By taking charge of the billing and controlling when calls are routed, the physician can focus on patient care. Most physicians are frustrated with the current healthcare system and its emphasis on volume of patients. However, most primary care physicians do not realize how frustrated the patients also are, or that many of those patients are willing to participate in a solution that would improve communication. The physician/patient communication system, as disclosed herein, allows patients a way to reach the patient's cell phone but, only during the times the physician allows. Patients pay (e.g., monthly) for this service and are seeking to minimize their loss of time for every time they need to talk directly with the physician. As physicians know, many health problems or questions are quickly resolvable with a direct phone call. However, until now this has been financially unacceptable for all concerned. Patients know that the physician deserves to be paid for the physician's time but they too spend a fortune in lost hours and wasted time simply getting access to the patient's advice. Many of these patients are willing to sign up for this program and are waiting for the physician to invite them. According to the various embodiments described herein, the physician's patients can select a physician as their physician. In certain embodiments, they then receive an access code which allows them to call in on a toll-free (e.g., “800”) line and then direct their incoming calls to the physician's telephone (e.g., “landline” phone or cell phone). Various embodiments of the system are capable of handling billing and set up while providing the following reports: a statement of patients in the physician's program and when they enrolled, a report of minutes used and number of calls for each patient and a summary of patient revenue and fees. The system may also provide payment (e.g., a check or electronic fund transfer) for fees earned.

According to one embodiment, if a patient chooses not to renew, that patient's access code will expire, and they will no longer be granted access to the physician. The patient is then relegated to seeing a physician in the normal course. According to a related embodiment, a physician can choose how many patients the physician will allow in the physician's program and what, if any, impact the physician will allow the program to have on the physician's work day. In one specific embodiment, the cost to the physician is such that break-even is reached at only three patients, meaning that the physician begins to experience net income when the fourth patient joins the program.

Before describing various embodiments of the system and method disclosed herein, a general discussion of computing and network environments within with the system can be embodied and the method carried out will be undertaken.

FIG. 1 is a block diagram illustrating a network environment in which a system according to the invention may be practiced. As is illustrated in FIG. 1, network 100, such as a private wide area network (WAN) or the Internet, includes a number of networked servers 110(1)-(N) that are accessible by client computers 120(1)-(N).

Communication between the client computers 120(1)-(N) and the servers 110(1)-(N) typically occurs over a publicly accessible network, such as a public switched telephone network (PSTN), a DSL connection, a cable modem connection or large bandwidth trunks (e.g., communications channels providing T1 or OC3 service). The client computers 120(1)-(N) access the servers 110(1)-(N) through, for example, a service provider. This might be, for example, an Internet Service Provider (ISP) such as America On-Line™, Prodigy™, CompuServe™ or the like. Access is typically had by executing application specific software (e.g., network connection software and a browser) on the given one of the client computers 120(1)-(N).

One or more of the client computers 120(1)-(N) and/or one or more of the servers 110(1)-(N) may be, for example, a computer system of any appropriate design, in general, including a mainframe, a mini-computer or a personal computer system. Such a computer system typically includes a system unit having a system processor and associated volatile and non-volatile memory, one or more display monitors and keyboards, one or more diskette drives, one or more fixed disk storage devices and one or more printers. These computer systems are typically information handling systems which are designed to provide computing power to one or more users, either locally or remotely. Such a computer system may also include one or a plurality of I/O devices (i.e., peripheral devices) which are coupled to the system processor and which perform specialized functions. Examples of I/O devices include modems, sound and video devices and specialized communication devices. Mass storage devices such as hard disks, CD-ROM drives and magneto-optical drives may also be provided, either as an integrated or peripheral device. One such example, computer system, discussed in terms of the client computers 120(1)-(N) is shown in detail in FIG. 2.

It will be noted that the variable identifier “N” is used in several instances in FIG. 1 to more simply designate the final element (e.g., the servers 110(1)-(N) and the client computers 120(1)-(N)) of a series of related or similar elements (e.g., servers and client computers). The repeated use of such variable identifiers is not meant to imply a correlation between the sizes of such series of elements, although such correlation may exist. The use of such variable identifiers does not require that each series of elements has the same number of elements as another series delimited by the same variable identifier. Rather, in each instance of use, the variable identified by “N” may hold the same or a different value than other instances of the same variable identifier.

FIG. 2 depicts a block diagram of a computer system 210 suitable for implementing the invention and an example of one or more of the client computers 120(1)-(N). A computer system 210 includes a bus 212 which interconnects major subsystems of the computer system 210 such as a central processor 214, a system memory 216 (typically random-access memory, or RAM, but which may also include read-only memory, or ROM, flash RAM, or the like), an input/output controller 218, an external audio device such as a speaker system 220 via an audio output interface 222, an external device such as a display screen 224 via a display adapter 226, serial ports 228, 230, a keyboard 232 (interfaced with a keyboard controller 233), a storage interface 234, a floppy disk drive 236 operative to receive a floppy disk 238 and a CD-ROM drive 240 operative to receive a CD-ROM 242. Also included are a mouse 246 (or other point-and-click device, coupled to the bus 212 via the serial port 228), a modem 247 (coupled to the bus 212 via the serial port 230) and a network interface 248 (coupled directly to the bus 212).

The bus 212 allows data communication between a central processor 214 and a system memory 216, which may include RAM, ROM or flash memory, as previously noted. The RAM is generally the main memory into which the operating system and application programs are loaded and typically affords at least 16 megabytes of memory space. The ROM or flash memory may contain, among other code, the Basic Input-Output system (BIOS) which controls basic hardware operation such as the interaction with peripheral components. Applications resident with the computer system 210 are generally stored on and accessed via a computer readable medium, such as a hard disk drive (e.g., fixed disk 244), an optical drive (e.g., CD-ROM drive 240), a floppy disk unit 236 or other storage medium. Additionally, applications may be in the form of electronic signals modulated in accordance with the application and data communication technology when accessed via a network modem 247 or an interface 248.

The storage interface 234, as with the other storage interfaces of the computer system 210, may connect to a standard computer readable medium for storage and/or retrieval of information, such as a fixed disk drive 244. The fixed disk drive 244 may be a part of computer system 210 or may be separate and accessed through other interface systems. Many other devices can be connected, such as a mouse 246 connected to the bus 212 via serial port 228, a modem 247 connected to the bus 212 via serial port 230 and a network interface 248 connected directly to the bus 212. The modem 247 may provide a direct connection to a remote server via a telephone link or to the Internet via an internet service provider (ISP). The network interface 248 may provide a direct connection to a remote server via a direct network link to the Internet via a POP (point of presence). The network interface 248 may provide such connection using wireless techniques, including digital cellular telephone connection, Cellular Digital Packet Data (CDPD) connection, digital satellite data connection or the like.

Many other devices or subsystems (not shown) may be connected in a similar manner (e.g., bar code readers, document scanners, digital cameras and so on).

Conversely, it is not necessary for all of the devices shown in FIG. 2 to be present. The devices and subsystems may be interconnected in different ways from that shown in FIG. 2. The operation of a computer system such as that shown in FIG. 2 is readily known in the art and is not discussed in detail in this application. Code to implement the invention may be stored in computer-readable storage media such as one or more of the system memory 216, the fixed disk 244, the CD-ROM 242 or the floppy disk 238. Additionally, the computer system 210 may be any kind of computing device and so includes personal data assistants (PDAs), network appliance, X-window terminal or other such computing device. The operating system provided on the computer system 210 may be MS-DOS®, MS-Windows®, OS/2X, UNIX®, Linux® or other known operating system. The computer system 210 may also support a number of Internet access tools, including, for example, a Hypertext Transfer Protocol (HTTP)-compliant web browser having a JavaScript interpreter, such as Netscape Navigator® 3.0, Microsoft Explorer® 3.0 and the like.

The foregoing described embodiment wherein the different components are contained within different other components (e.g., the various elements shown as components of the computer system 210). It is to be understood that such depicted architectures are merely examples, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality.

FIG. 3 is a block diagram depicting a network 300 in which the computer system 210 is coupled to an internetwork 310, which is coupled, in turn, to client systems 320, 330, as well as a server 340. An internetwork 310 (e.g., the Internet or a wide-area network, or WAN) is also capable of coupling the client systems 320, 330 and the server 340 to one another. With reference to the computer system 210, the modem 247, the network interface 248 or some other method can be used to provide connectivity from the computer system 210 to the internetwork 310. The computer system 210, the client system 320 and the client system 330 are able to access information on the server 340 using, for example, a web browser (not shown). Such a web browser allows the computer system 210, as well as the client systems 320, 330, to access data on the server 340 representing the pages of a website hosted on the server 340. Protocols for exchanging data via the Internet are well known to those skilled in the art. Although FIG. 3 depicts the use of the Internet for exchanging data, the invention is not limited to the Internet or any particular network-based environment.

Referring to FIGS. 1, 2 and 3, a browser running on the computer system 210 employs a TCP/IP connection to pass a request to the server 340, which can run an HTTP “service” (e.g., under the WINDOWS® operating system) or a “daemon” (e.g., under the UNIX® operating system), for example. Such a request can be processed, for example, by contacting an HTTP server employing a protocol that can be used to communicate between the HTTP server and the client computer. The HTTP server then responds to the protocol, typically by sending a “web page” formatted as an HTML file. The browser interprets the HTML file and may form a visual representation of the same using local resources (e.g., fonts and colors).

Having undertaken a general discussion of computing and network environments within with the system can be embodied and the method carried out, various embodiments of the system and method disclosed herein will now be described.

FIG. 4 is a block diagram of one embodiment of a physician/patient communication system 400 constructed according to the principles of the invention. The system 400 includes an account manager 401, a report generator 402, a matching engine 403 and a telephony interface 404. In the illustrated embodiment, the account manager 401, the report generator 402, and the matching engine 403 are embodied as sequences of software instruction executable in a general-purpose computer that includes a processor 405 and memory 406. The illustrated embodiment of the telephony interface 404 likewise includes sequences of software instructions executable in a general purpose computer, but also includes telephone interface hardware coupled to the processor 405 and the memory 406 that enables the system 400 to place, receive and connect telephone calls in a manner that will be described below.

One or more patients, represented in FIG. 4 by a patient 410, and one or more physicians, represented by a physician 440, interact with the system 400 over time. The patient 410 has access to a computer network, such as the Internet, with which he may interact via a browser and electronic mail (“email”) 420. The patient 410 also has access to a telephone 430, which may be a landline or a cell phone. Likewise, the physician 440 has access to a computer network, such as the Internet, with which he may interact via a browser and email 450. The physician 440 also has access to a telephone 460, which may be a landline or a cell phone.

The account manager 401 is configured to interact with the patient 410 via the browser or email 420 or the telephone 430. In the illustrated embodiment, the account manager 401 is configured to interact with the patient 410 via the browser 420. The account manager 401 is configured to receive information from the patient 410 in order to establish an account with the system 400 for the patient 410. In the illustrated embodiment, the account includes information identifying the patient 410 and allowing the system 400 to collect payments from the patient 410 for services rendered to the patient 410. The account manager 401 is configured to interact with the patient 410 via the browser or email 420 or the telephone 430. In the illustrated embodiment, the account manager 401 is also configured to interact with the physician 440 via the browser 450. The account manager 401 is configured to receive information from the physician 440 in order to establish an account with the system 400 for the physician 440. In the illustrated embodiment, the account includes information identifying the physician 440, such as his biographical information, specialty, times during which the physician can accept calls, whether or not his practice accommodates the addition of additional patients and his billing rate. The information in the physician's account also allows the system 400 to send payments to the physician 440 for services rendered by the physician 440.

The report generator 402 is configured to provide one or more reports to the patient 410 and the physician 440. The reports may involve telephone calls made or received, date, time and duration of calls, identities of patients and physicians and details regarding payments payable, paid, receivable or received. The reports may also include reports to operators of the system 400 regarding its overall operation.

The matching engine 403 is configured to match physicians and patients. In an embodiment to be described, the matching engine 403 allows a patient to search for physicians by name, location or specialization and determine whether or not such physicians are open to taking additional patients.

The telephony interface 404 couples the system 400 to a public switched telephone network (PSTN) or a computer network, such as the Internet, for communication via voice-over-Internet-Protocol (VoIP). In various embodiments, the telephony interface 404 is capable of providing communication with patients and physicians allowing accounts to be established, reports to be provided, physician/patient matches to be made and phone calls to be made between patients and physicians. In one embodiment, the telephony interface 404 includes a conventional telephony board commercially available from Dialogic, Corporation, of Montreal, Quebec, Canada. In another embodiment, the telephony interface 404 is provided through VoiceShot, an Internet-based service for placing and receiving telephone calls, sending and receiving text messages, hosting interactive voice response applications and performing call center functions. VoiceShot is commercially available on the Internet at voiceshot.com.

In one specific embodiment, the patient 410 employs the telephone 430 to call the telephony interface 404. The patient 410 then enters an access code. Upon verification, the telephony interface 404 places a call to the telephone 460 associated with the physician 440, and services are rendered. In the illustrated embodiment, the system 400 does not allow the patient 410 to see the telephone number of the physician 440 and does not allow the patient to contact the physician outside of the system 400.

The telephony interface 404 can supply information to the system 400 regarding the date, time and duration of call the call and even cause the call to be recorded if such is allowed and desired. In another specific embodiment, the patient 410 employs the browser 420 to call the telephony interface 404. The patient 410 then enters an access code. Upon verification, the telephony interface 404 places a call to the browser 450 associated with the physician 440, and services are rendered. The telephony interface 404 can supply information to the system 400 regarding the date, time and duration of call the call and even cause the call to be recorded if such is allowed and desired. Of course, the telephony interface 404 allows a call to be made from or to either the Internet or the PSTN.

FIG. 5 is a flow diagram of one embodiment of a method of managing physician/patient communication carried out according to the principles of the invention. The method begins in a start step 505.

In a step 510, physician accounts are established. In one embodiment, each physician provides contact and biographical information and specialty and indicates how many patients he is willing to accept and when he is available to take calls.

In a step 515, patient accounts are established. In one embodiment, each patient provides contact and payment information. In a more specific embodiment, each patient selects a plan under which a certain level of service is provided for a fixed charge (i.e., a subscription).

In a step 520, patients and physicians are matched with one another. Through a browse or search function, patients can see what physicians are available and can accept additional patients. The patients can then sign up with those physicians.

In a step 525, communication is enabled between patients and physicians. Over time, patients make telephone calls through the system. The system keeps track of those calls, creating records of the same. In a step 530, reports are provided to the patients and the physicians. A report to a patient may, for example, be made monthly and detail the times, dates, numbers and durations of calls made to physicians and relate the charges pertaining to such calls. A report to a physician may, for example, be made monthly and detail the times, dates, numbers and durations of calls made by patients and calculate the income, profit and effective billing rate of the physician. The method ends in an end step 535.

Having described various examples of systems and methods falling within the scope of the invention, examples of screen shots will now be illustrated and described. The screen shots are, in general, representative of information provided to a subscribing patient via the browser 420 of FIG. 4.

FIG. 6 is a portion of an image (a screen shot) presentable on a computer monitor and regarding the establishing of an account for a patient. It is apparent that several fields are presented to a patient wishing to establish an account with the system. The patient fills in these fields, thereby presenting information to the system.

FIG. 7 is a portion of an image presentable on a computer monitor and regarding billing details for a patient. Several fields are presented to the patient allowing the patient to provide billing information to the system. In the illustrated embodiment, the billing information includes credit card information.

FIG. 8 is a portion of an image presentable on a computer monitor and regarding the addition of a patient to a given account. This feature, available in certain embodiments, allows more than one patient to be associated with a single account. For example, a head-of-household may wish to establish an account for himself and others in his household and pay for all patients using the same credit card.

FIG. 9 is a portion of an image presentable on a computer monitor and regarding the choosing of a payment plan for a subscribing patient. By means of this image, a patient can choose from among multiple plans, including subscriptions offering different levels of service.

FIG. 10 is a portion of an image presentable on a computer monitor and regarding medical service charge authorization for a subscribing patient. The patient can then confirm that he will be charged for the plan selected.

FIG. 11 is a portion of an image presentable on a computer monitor and regarding biographical information details for a subscribing physician. As described above, patients are matched to physicians. Unless a given patient is already aware of a given physician (perhaps through a preexisting relationship), biographical information allows patients to make informed decisions regarding physicians before selecting them to be their physicians.

FIG. 12 is a portion of an image presentable on a computer monitor and regarding patient/physician matching. By means of the fields presented in FIG. 12, a patient is allowed to browse or search for physicians appropriate for the desired consultation.

FIG. 13 is a portion of an image presentable on a computer monitor and regarding summary information for a subscribing patient. Having established an account and been matched with a physician, a patient can now be shown a summary of his status with the system.

FIG. 14 is a portion of an image presentable on a computer monitor and regarding a list of patients for physicians. FIG. 14 is an example of a report providable to an operator of the system showing contact information for patients and relationships among patients and physicians.

FIG. 15 is a portion of an image presentable on a computer monitor and regarding a waiting list for a subscribing physician. FIG. 15 is an example of a report providable to a physician whose practice is limited to a certain number of patients. The report shows whether or not that limit has been reached and, if the limit has been reached how many patients are on his waiting list. The report may assist the physician in determining whether his practice should be expanded.

Those skilled in the art to which this application relates will appreciate that other and further additions, deletions, substitutions and modifications may be made to the described embodiments.

What is claimed is:

1. A physician/patient communication system, comprising:
an account manager configured to interact with at least one patient and at least one physician to allow at least one patient account and at least one physician account to be established;
a report generator coupled to said account manager and configured to provide one or more reports to said at least one patient and said at least one physician;
a matching engine coupled to said report generator and configured to match said at least one patient with said at least one physician; and
a telephony interface coupled to said matching engine and configured to enable communication between said at least one patient and said at least one physician.

2. The system as recited in claim 1 wherein said account manager is configured to interact with said at least one patient and said at least one physician via one or more of:
a browser,
electronic mail, and
a telephone.

3. The system as recited in claim 1 wherein said telephony interface is configured to receive a call from a patient, receive an access code from said patient and place a call to a physician only if said access code is valid.

4. The system as recited in claim 3 wherein said telephony interface is further configured to place said call to said physician only if said access code is valid and only during times allowed by said physician.

5. The system as recited in claim 3 wherein said telephony interface is further configured to indicate that said physician is busy if said call is outside of times allowed by said physician.

6. The system as recited in claim 3 wherein said telephony interface is further configured to cause a record of said call to be made.

7. The system as recited in claim 1 wherein said one or more reports include:
telephone calls made or received,
date, time and duration of calls,
identities of patients and physicians, and
details regarding payments payable, paid, receivable or received.

8. A method of managing physician/patient communication, comprising:
interacting with at least one patient and at least one physician to allow at least one patient account and at least one physician account to be established;
providing one or more reports to said at least one patient and said at least one physician;
matching said at least one patient with said at least one physician; and
enabling communication between said at least one patient and said at least one physician.

9. The method as recited in claim 8 wherein said account manager is configured to interact with said at least one patient and said at least one physician via one or more of:
a browser,
electronic mail, and
a telephone.

10. The method as recited in claim 8 wherein said telephony interface is configured to receive a call from a patient, receive an access code from said patient and place a call to a physician only if said access code is valid.

11. The method as recited in claim 10 wherein said telephony interface is further configured to place said call to said physician only if said access code is valid and only during times allowed by said physician.

12. The method as recited in claim 10 wherein said telephony interface is further configured to indicate that said physician is busy if said call is outside of times allowed by said physician.

13. The method as recited in claim 10 wherein said telephony interface is further configured to cause a record of said call to be made.

14. The method as recited in claim 8 wherein said one or more reports include:
telephone calls made or received,
date, time and duration of calls,
identities of patients and physicians, and
details regarding payments payable, paid, receivable or received.

15. A physician/patient communication system, comprising:
an account manager configured to interact with at least one patient and at least one physician via one or more of:
a browser,
electronic mail, and
a telephone
to allow at least one patient account and at least one physician account to be established;
a report generator coupled to said account manager and configured to provide one or more reports to said at least one patient and said at least one physician;
a matching engine coupled to said report generator and configured to match said at least one patient with said at least one physician; and
a telephony interface coupled to said matching engine and configured to enable communication between said at least one patient and said at least one physician, said account manager, said report generator and said matching engine embodied at least in part in a sequence of software instructions executable in a general-purpose computer.

16. The system as recited in claim 15 wherein said telephony interface is configured to receive a call from a patient, receive an access code from said patient and place a call to a physician only if said access code is valid.

17. The system as recited in claim 16 wherein said telephony interface is further configured to place said call to said physician only if said access code is valid and only during times allowed by said physician.

18. The system as recited in claim 16 wherein said telephony interface is further configured to indicate that said physician is busy if said call is outside of times allowed by said physician.

19. The system as recited in claim 16 wherein said telephony interface is further configured to cause a record of said call to be made.

20. The system as recited in claim 15 wherein said one or more reports include:
telephone calls made or received,
date, time and duration of calls,
identities of patients and physicians, and
details regarding payments payable, paid, receivable or received.
